(19) United States
(12) Patent Application Publication
(10) Pub. No.: US 2007/0035795 A1
(43) Pub. Date: Feb. 15, 2007

(54) Artificial facet joint and a method of making same

(76) Inventor: Jason R. Hubbard, Franklin, TN (US)

Correspondence Address: WADDEY & PATTERSON, P.C., 1600 DIVISION STREET, SUITE 500, NASHVILLE, TN, 37203, US

(21) Appl. No.: 11/197,098

(22) Filed: Aug. 4, 2005

(51) Int. Cl. G02B 26/08

(52) U.S. Cl. 359/203

(57) ABSTRACT

An artificial facet is implanted and attached to the spine. The artificial facet is an assembly of components that includes a rod formed of first and second curved sections. First and second pedicle screws are connected to the first and second curved sections, respectively. The first curved section has a sliding engagement with the second curved section along a curved longitudinal axis to allow adjustment of the length of the rod along the curved longitudinal axis. Each of the first and second pedicle screws incorporates a polyaxial head to enable lateral movement of each of the pedicle screws in a plane transverse to the curved longitudinal axis of the rod. The first and second pedicle screws are connected to the respective first and second curved sections with set screws so that the position of the pedicle screws along the curved sections is adjustable.

A portion of the discloser of this patent document contains material that is subject to copyright protection. The copyright owner has no objection to the facsimile reproduction by anyone of the patent document or the patent discloser, as it appears in the U.S. Patent and Trademark Office patent file or records, but otherwise reserves all copyright rights whatsoever.

All patents and publications mentioned herein are hereby incorporated by reference in their entireties.

### CROSS-REFERENCES TO RELATED APPLICATIONS

Not applicable.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to medical devices used for repair or reconstruction of supporting structures in the human spine. More specifically, the present invention pertains to implantable devices and methods used to repair or replace damaged facet joints in the human spine.

The joints between the bones in the human spine are what allow us to bend backward and forward and to twist and turn. The facet joints are a particular joint between each vertebral body that facilitate twisting and rotation of the spine. The facet joints are part of the posterior members of each vertebra. Each vertebra has facet joints that connect it with the vertebrae above and the vertebrae below in the spinal column. The facet joints are synovial joints. The ends of the bones that make up a synovial joint are covered with articular cartilage, a slick spongy material that allows the bones to glide against one another without much friction. Synovial fluid inside the joint keeps the joint surfaces lubricated. This fluid is contained inside the joint by the joint capsule, a watertight sac of soft tissue and ligaments that fully surrounds and encloses the joint.

Like other structures in the spine, facet joints are subject to damage or becoming non-functional due to disease (e.g., spondylolisthesis), iatrogenic destabilization, or trauma. The current treatment for a damaged or non-functioning facet joint is spinal fusion. However, in order to maintain normal movement of the spine and to prevent junction level disease, replacement of the disc and facet would be required. Disc replacement alone will not provide a joint structure that resists translation and rotational forces and therefore is not indicated for treatment of spondylolisthesis. On the other hand, replacement of the facet alone can be used before disc degeneration occurs and would likely prevent further degeneration of the disc.

Numerous implantable devices have been developed for use in repairing other spinal structures. Unfortunately, these prior art devices have numerous drawbacks. For example, they fail to provide proper rotational movement at the anchor point to allow a full range of normal movement within the spine. Additionally, the connection pieces of these devices fail to exhibit the proper curvature to mimic lordosis. Additionally, most of these prior art devices either have no, or very little, traversing movement once installed in the body. As such, these prior art devices fail to allow cephalad and caudad movement and fail to properly recapitulate the flexion and extension of the spine.

What is needed then is a device for replacing a facet joint and a method of implanting and securing such a device in the human spine. This needed device and method must provide the proper support for an injured spine and yet still provide a high degree of freedom of movement to attempt to mimic the amount of movement in a healthy spine.

### BRIEF SUMMARY OF THE INVENTION

In the present invention, an artificial facet is implanted and attached to the spine. One embodiment of the artificial facet is an assembly of components that includes a rod formed of first and second curved sections. First and second pedicle screws are connected to the first and second curved sections, respectively. The first curved section is slideably engaged with the second curved section along a curved longitudinal axis. This allows adjustment of the length of the rod along the curved longitudinal axis. Additionally, each of the first and second pedicle screws incorporates a polyaxial head to enable lateral movement of each of the pedicle screws in a plane transverse to the curved longitudinal axis of the rod. The first and second pedicle screws are connected to the respective first and second curved sections with first and second set screws so that the position of the pedicle screws along the curved sections is adjustable.

Thus, the artificial facet of this invention has a first curved member with a first connection groove and a first longitudinal axis such that the curve of the first curved member is along the first longitudinal axis. A second curved member has a second longitudinal axis such that the curve is along the second longitudinal axis. The second curved member includes a second connection groove shaped to slideably engage the first connection groove on the first curved member. A first anchor is transversely attached to the first curved member and shaped to be secured to the spine. A second anchor is transversely attached to the second curved member and shaped to be secured to the spine. When the assembly is implanted, the first and second anchors can be positioned in adjacent bony spinal structures with the first and second curved members engaged for sliding movement.

In a preferred embodiment, each anchor includes a threaded member, a connection housing, and a tightening member. The threaded member includes a housing end and a threaded end wherein the housing end engages a socket on the connection housing that is shaped to accept the housing end. The threaded end of the threaded member is designed to be implemented into bone located in the body. The connection housing includes an aperture shaped to accept one of the curved members and a threaded opening positioned opposite the socket.

The housing end of the threaded member engages the socket of the connection housing to provide a pivoting coupling between the threaded member and the connection housing. The aperture can extend from the thread opening towards this socket to form a slot in the connection housing to accept one of the curved members.

The connection housing can further include a cavity extending from the threaded opening to the socket to accept the tightening member, one of the curved members, and the housing end of the threaded member. Within the cavity can be a gap between the aperture and the socket. This gap can space the housing end of the threaded member from one of the curved members when the threaded member and one of the curved members are positioned within the cavity.

The tightening member is shaped to secure one of the curved members to the connection housing and can engage the threaded opening of the connection housing to secure one of the curved members in an adjustable position.

The sliding engagement between the first connection groove and the second connection groove restricts rotational movement of the first curved member relative to the second curved member. Additionally, this sliding engagement can facilitate choreographed movement of the first anchor with respect to the second anchor and the first curved member relative to the second curved member.

In a more preferred embodiment, each curved member is an elongated rod having a rounded end opposite the connection groove. Additionally, the curved members can be substantially identical in shape and design.

The invention includes a method of creating an artificial facet joint. The method includes: (1) positioning first and second polyaxial head pedicle screws in bone; (2) positioning the ends of a curved, linearly adjustable rod within each polyaxial head of the first and second polyaxial head pedicle screws; and (3) securing the ends of the rod within each polyaxial head.

One object of the present invention is to provide an artificial orthopedic facet.

Another object of the present invention is to provide a method for creating an artificial facet joint.

Still another object of the present invention is to provide an orthopedic device for insertion into bone located in a body having first and second anchors connected by first and second curved members.

Another object of the present invention is to provide an orthopedic device that is curved to mimic lordosis.

Still another object of the present invention is to provide an orthopedic device that can be anchored into bone wherein at least a portion of the anchors in the bone have the ability to move cephalad and caudad.

Another object of the present invention is to provide an orthopedic device that provides proper support for a spinal movement while maintaining an amount of flexibility for flexion and extension of a joint in the spine.

Other and further objects, features and advantages of the present invention will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 is an exploded view of the artificial facet assembly in accordance with the present invention.

FIG. 2 is a partial cutaway side view of the assembly of FIG. 1, including a portion in phantom to illustrate the pivoting movement of one of the anchors as provided by the polyaxial head pedicle screw.

FIG. 3 is an end view of the assembly as seen in FIG. 2.

FIG. 4 is a side view of an anchor as used in the assembly of FIGS. 1-3.

FIG. 5 is a top view of the assembly shown in FIG. 2.

FIG. 6 is a side view of the rod component of the assembly of FIGS. 1-2, with the curved sections of the rod partially engaged.

FIG. 7 is an enlarged detail view of the portion of the assembly circled and labeled as “7” on FIG. 2.

FIG. 8 is a side view of the artificial facet assembly of FIGS. 1-2 after spinal implantation and with spine and assembly in a neutral position.

FIG. 9 is a side view similar to FIG. 8 with the spine and assembly in a flexion position.

FIG. 10 is a side view similar to FIG. 8 with the spine and assembly in extension position.

### DETAILED DESCRIPTION OF THE INVENTION

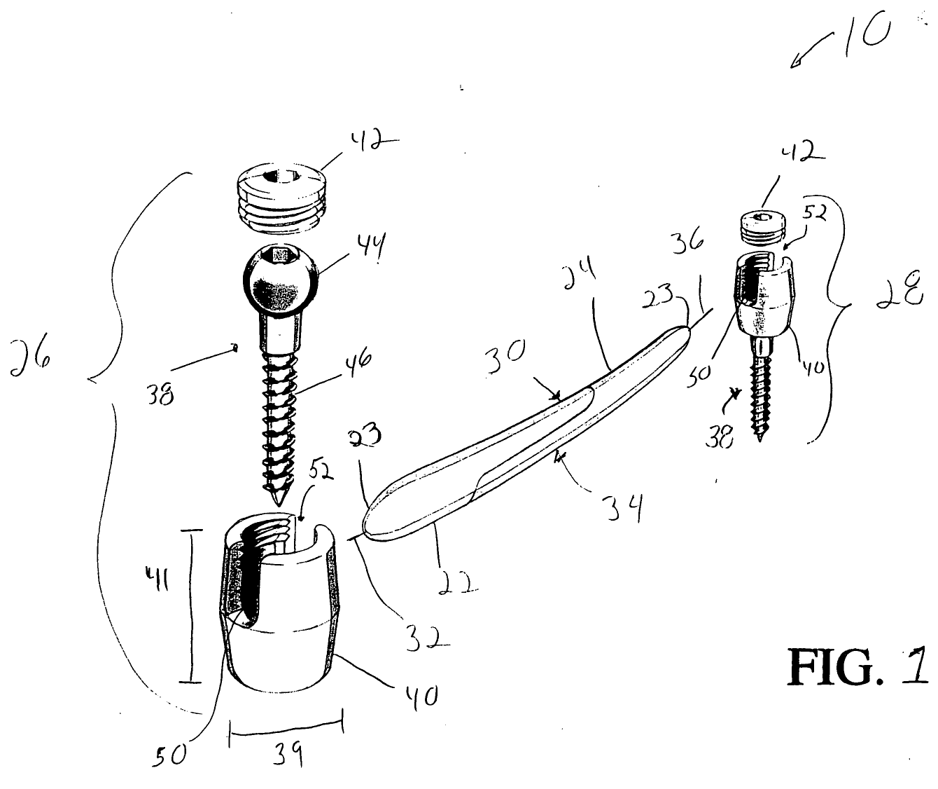

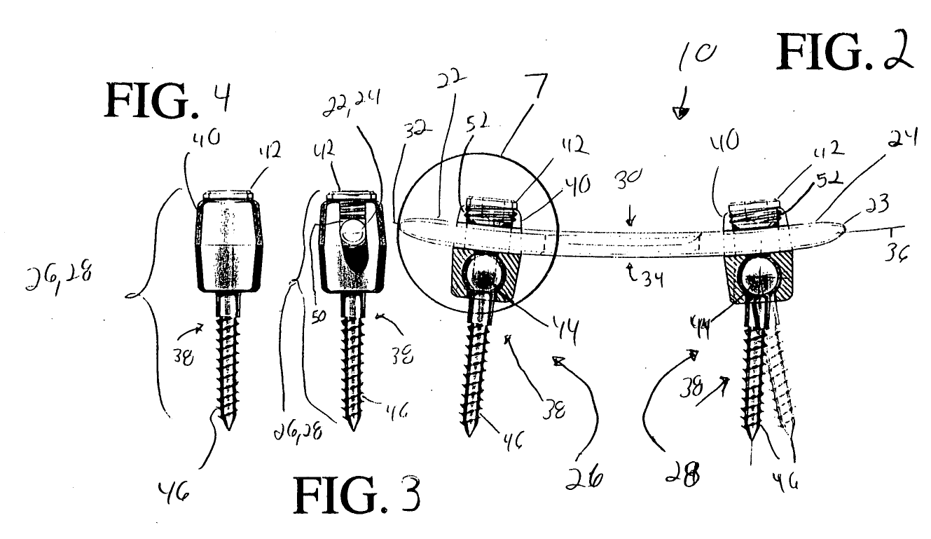

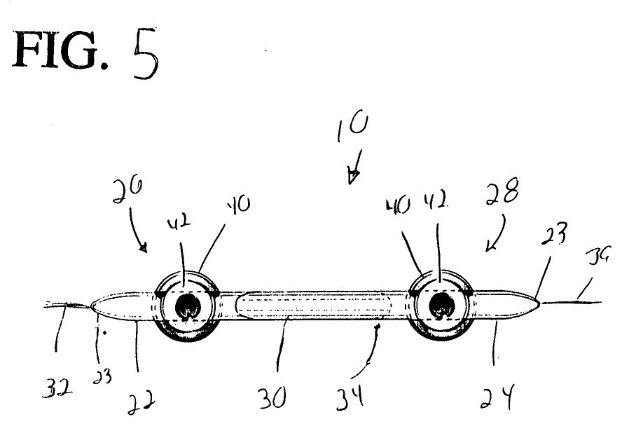

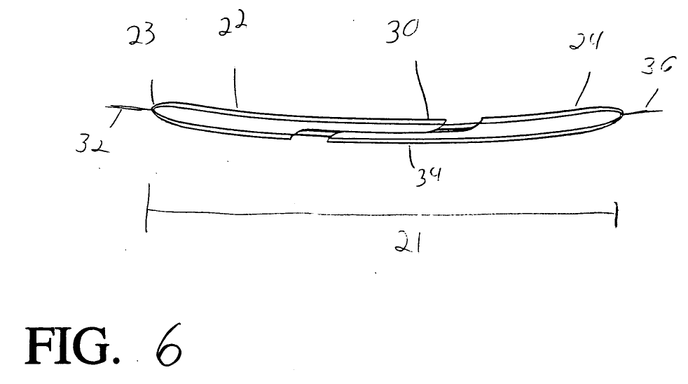

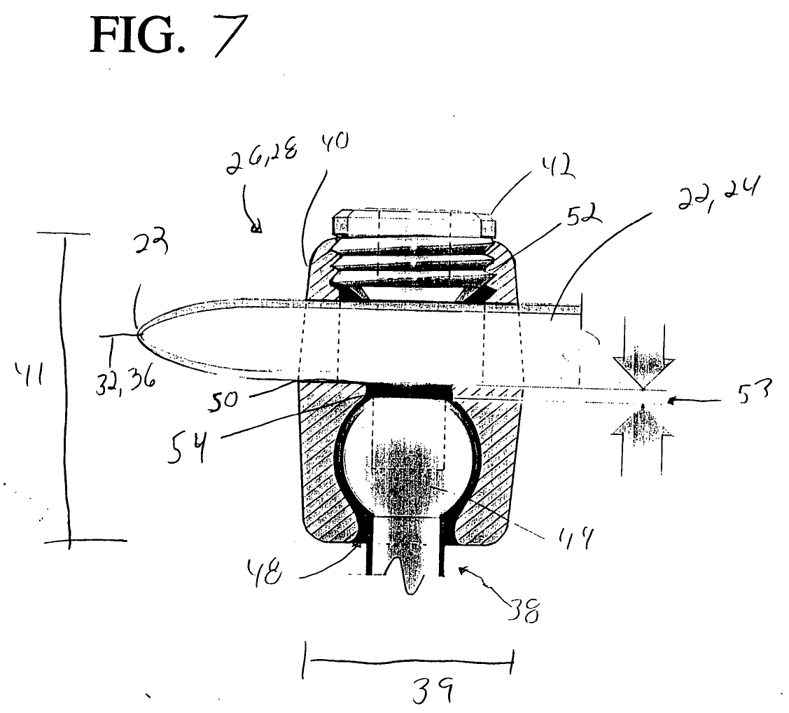

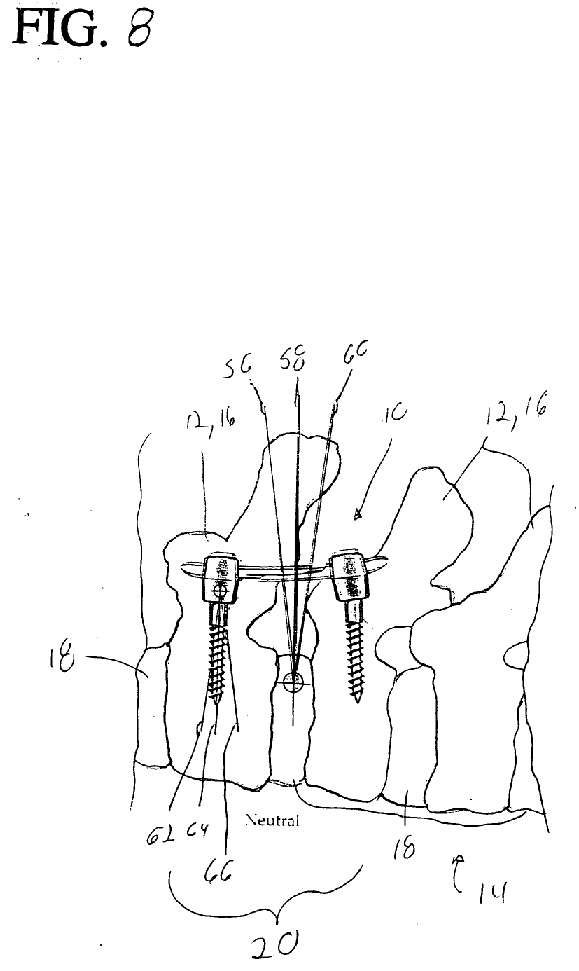

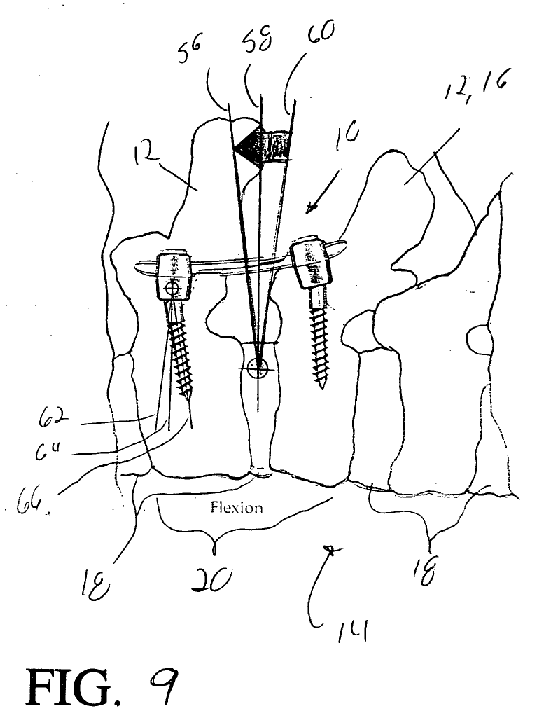

Referring generally now to FIGS. 1-10, an implantable orthopedic medical device is shown and generally designated by the numeral 10. The device 10 is primarily intended for insertion into bone segments 12 located in a human spine 14. Preferably the bone segments 12 are individual vertebra 16 separated by inter-vertebral discs 18. More preferably, the orthopedic device 10 is used to assist and/or support a facet joint 20 located in the spine 14. In this embodiment, the orthopedic device 10 can be described as an artificial facet 10 that can resist rotational forces and translational forces in the lumbar or thoracic spine.

The device 10 is an assembly of components that include a rod formed of a first curved member 22 and a second curved member 24, a first anchor 26, and a second anchor 28. The first curved member 22, which can be described as a first elongated member 22 or a first curved section 22, includes a first connection groove 30 and a first longitudinal axis 32, wherein the curvature of the first curved member 22 is along the first longitudinal axis 32. The second curved member 24, which can be described as a second elongated member 24 or a second curved section 24, includes a second connection groove 34 and a second longitudinal axis 36 wherein the curve or curvature of the second curved member 24 is along the second longitudinal axis 36. Additionally, the second connection groove 34, which can be described as a second connector end 34, is shaped to slideably engage the first connection groove 30, which can be described as a first connector end 30. The first and second connector ends 30 and 34 can be described as being shaped to traverse one another.

Preferably the sliding engagement between the first connection groove 30 and the second connection groove 34 restricts rotational movement of the first curved member 22 relative to the second curved member 24. The curved members 22 and 24 are preferably elongated rod sections having a rounded end 23 positioned opposite the connection groove 30 or 34, respectively. The first and second curved members 22 and 24 can be substantially identical.

The first anchor 26 is removably attached to the first curved member 22 and is shaped to be secured to the bone 12. The second anchor 28 is removeably attached to the second curved member 24 and also shaped to be secured in the bone 12.

Each anchor 26 and 28 includes a threaded member 38, connection housing 40, and tightening member 42. Each threaded member 38 includes a housing end 44 and a threaded end 46 wherein the threaded end 46 is shaped to be inserted into bone 12. The housing end 44, which can be described as a spherical end 44, is shaped to provide a pivoting engagement with a socket 48 of the connection housing 40.

The connection housing 40 further includes an aperture 50 shaped to accept one of the curved members 22 or 24. Preferably the aperture 50 extends from the threaded opening 52 of the connection housing 40 towards the socket 48 to form a slot in the connection housing 40. As such, the aperture 50 can be described as a slotted aperture 50. The thread opening 52 is positioned opposite the socket 48 to accept the tightening member 42 to secure one of the curved members 22 or 24 to the connection housing 40.

The connection housing 40 can further include a cavity 54 extending from the threaded opening 52 to the socket 48. A gap 53 spaces the aperture 50 from the socket 48. This can effectively space the threaded member 38, and more specifically the housing end 44 of the threaded member 38, from one of the curved members 22 or 24 when the threaded member 38 and one of the curved members 22 or 24 are positioned within the cavity 54.

The sliding engagement between the first and second connector ends 30 and 34 of the first and second curved members 22 and 24 restricts rotational movement of the first curved member 22 relative to the second curved member 24. This restricted rotational movement is further facilitated by the coupling of the first and second curved members 22 and 24 to the first and second anchors 26 and 28, respectively. Since each curved member 22 or 24 is fixed in one of the anchors 26 or 28, the engagement between the first and second connector ends 30 and 34 facilitates a coordinated and substantially uniform movement between the first and second curved members 22 and 24. This in turn facilitates a coordinated and substantially uniform movement between the connection housings 40 of the first and second anchors 26 and 28 in directions that are not substantially parallel with the longitudinal axis 32 and 36. This is best illustrated in FIGS. 8-10.

The connection housings 40 can be described as pivoting or polyaxial heads 40. The cavity 54 of the connection housing 40 can extend the length 41 of the connection housing. While the aperture 50 of the connection housing 40 can traverse the width 39 of the connection housing 40.

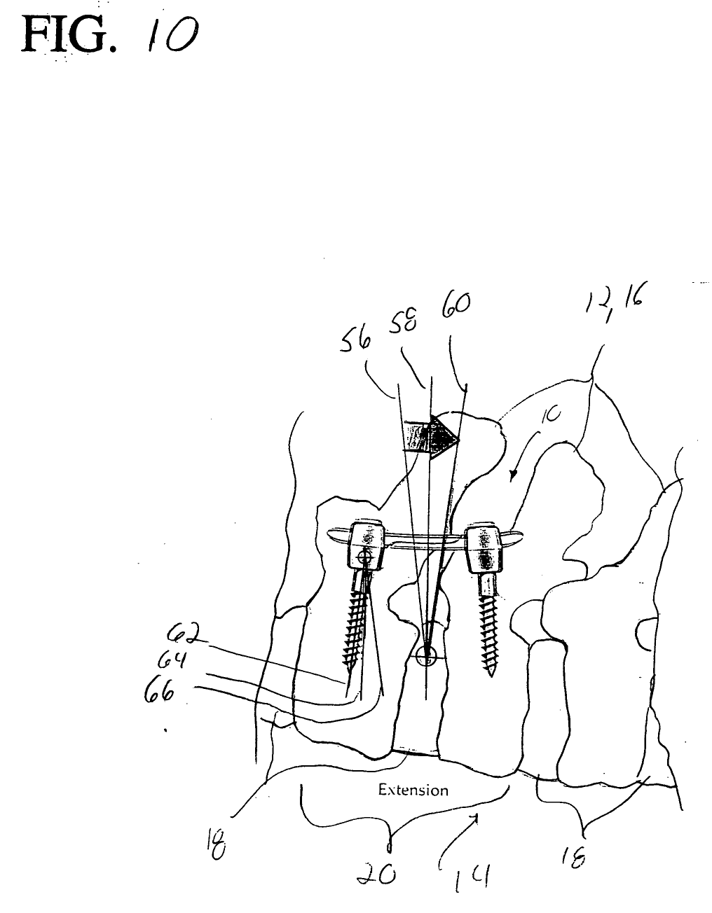

FIGS. 8-10 shows the device 10 positioned in bone 12 of the spine 14. FIG. 8 shows the device and spine in a neutral position. FIG. 9 shows the device 10 and a spine in a flexion position FIG. 10 shows the device 10 and the spine 14 in an extension position. As can be seen, the sliding engagement between the first curved member 22 and the second curved member 24 allows a curvilinear movement of the first curved member 22 relative to the second curved member 24. Alternately described, the movement of the first connector end 30 with respect to the second connector end 34 is substantially restricted to a plane substantially parallel to the first and second longitudinal axes 32 and 36. Since the curved members 22 and 24 are fixed to the anchors 26 and 28, once the device 10 is inserted in the body, each curved member 22 and 24 is restricted from moving independently with respect to the anchor 26 or 28 to which it is fixed. The result is a controlled substantially linear (or curvilinear) movement of the curved members 22 and 24. The reference lines 56, 58, and 60 illustrate related movement of the curved members 22 and 24.

FIGS. 8-10 also illustrate pivoting of the connection housings 40 on the threaded members 38. As seen in these figures, the threaded members 38 are fixed in the bone 12, yet the connection housings 40 are allowed to pivot with reference to the threaded member 38 as illustrated by lines 62, 64, and 66. As facilitated by the connection between the curved members 22 and 24 and the anchors 26 and 28 and the operative engagement between the connector ends 30 and 34, independent pivoting movement of the connection housing 40 of the first anchor 26 with respect to the connection housing 40 of the second anchor 28 is restricted.

In a more preferred embodiment, the artificial facet 10 includes a rod formed of first and second curved sections 22 and 24 slideably engaged along a curved longitudinal axis. First and second pedicle screws 26 and 28 are transversely connected to the first and second curved sections 22 and 24 respectively. Each of the first and second pedicle screws 26 and 28 include a polyaxial head 40 enabling lateral movement of each of the pedicle screws 26 and 28 in at least one plane transverse to the curved longitudinal axis. The first and second pedicle screws 26 and 28 are connected to the respective first and second curved sections 22 and 24 with first and second set screws 42.

The combination of the first and second curved sections 22 and 24 can be described as a rod that is capable of lengthening to recapitulate the flexion and extension of the spine 14. The adjustable rod includes a variable amount of displacement that can accommodate a range of movement. The rod can increase preferably up to 30% in length, and can mimic lordosis. The rod can lengthen in the coronal plane while the pedicle screws 26 and 28, and more specifically the connection head 40, can move cephalad and caudad. A range of motion stop member can be configured into the pedicle screws 26 and/or 28 to control the overall movement of the device 10.

Preferably the device 10 is formed of surgical stainless steel; however other materials known to be appropriate for implantation in a body can be used. Additionally, the preferred diameter of the screws used in the anchors 26 and 28 can vary from approximately 5.5 millimeters to 7.5 millimeters while the overall length of the combination of each of the first curved sections 22 and 24 is approximately 4.5 millimeters while the curvature of each curved section 22 and 24 is approximately 10 degrees.

Thus, although there have been described particular embodiments of the present invention of a new and useful Artificial Facet Joint and a Method of Making the Same, it is not intended that such references be construed as limitations upon the scope of this invention except as set forth in the following claims.

What is claimed is:

1. A device for insertion into bone located in a body, the device comprising:
a first curved member including a first connection groove and a first longitudinal axis and wherein the first curved member is curved along the first longitudinal axis;
a second curved member including a second connection groove shaped to provide a sliding engagement with the first connection groove, the second curved member being curved along a second longitudinal axis and;
a first anchor attached to the first curved member and shaped to be secured in bone; and
a second anchor attached to the second curved member and shaped to be secured in bone.

2. The device of claim 1, wherein each of the first and second anchors includes:
a threaded member having a housing end and a threaded end;
a connection housing having
a socket shaped to accept the housing end;
an aperture shaped to accept one of the curved members; and
a threaded opening positioned opposite the socket; and
a tightening member shaped to secure a respective first or second curved member to the connection housing.

3. The device of claim 2, wherein the housing end pivotably engages the socket.

4. The device of claim 2, wherein the aperture extends from the threaded opening toward the socket to form a slot in the connection housing.

5. The device of claim 2, further including a cavity extending from the threaded opening to the socket.

6. The device of claim 5, further including a gap spacing the aperture from the socket to space the threaded member from one of the first or second curved member when the threaded member and one of the first or second curved members are positioned the within the cavity.

7. The device of claim 1, wherein the sliding engagement between the first connection groove and the second connection groove restricts rotational movement of the first curved member relative to the second curved member.

8. The device of claim 1, wherein each of the first and second curved members is an elongated rod having a rounded end opposite the connection groove.

9. The device of claim 1, wherein the first curved member and the second curved member are substantially identical.

10. A device for insertion into bone located in a body, the device comprising:
a first elongated member including a first connector-end and a first longitudinal axis, the first elongated member being curved along the first longitudinal axis;
a second elongated member including a second longitudinal axis and a second connector-end shaped to traverse the first connector-end, the second elongated member being curved along the second longitudinal axis;
a first anchor adjustably fixed to the first elongated member and including a threaded member having a spherical end and a threaded end shaped to be fixed in bone;
a connection housing having:
a socket rotatively engaging the spherical end;
a slotted aperture shaped to accept the first elongated member; and
a threaded opening positioned opposite the socket; and
a tightening member shaped to secure the first elongated member in the slotted aperture; and
a second anchor removably fixed to the second elongated member and including
a threaded member having a spherical end and a threaded end shaped to be fixed in bone;
a connection housing having:
a socket rotatively engaging the spherical end;
a slotted aperture shaped to accept the second elongated member; and
a threaded opening positioned opposite the socket; and
a tightening member shaped to secure the second elongated member in the slotted aperture.

11. The device of claim 10, wherein the first connector-end and the second connector-end define a sliding engagement between the first elongated member and the second elongated member that restricts rotational movement of the first elongated member relative to the second elongated member.

12. The device of claim 11, wherein the sliding engagement between the first elongated member and the second elongated member allows substantially linear movement of the first elongated member relative to the second elongated member.

13. A device for insertion into bone located in a body, the orthopedic device comprising:
a first anchor including:
a first threaded member shaped to be fixed in bone; and
a first rotating head rotatively engaging the first threaded member, the first rotating head including a first aperture;
a second anchor including:
a second threaded member shaped to be fixed in bone; and
a second rotating head rotatively engaging the second threaded member, the second rotating head including a second aperture;
a first curved member including a first longitudinal axis, a first connector-end and a first anchor end releasably fixed in the first aperture;
a second curved member including a second longitudinal axis, a second connector-end shaped to engage the first connector-end and an second anchor end releasably fixed in the second aperture; and
the first connector-end and the second connector-end define an operative engagement that substantially restricts movement of the first connector-end with respect to the second connector-end to a plane substantially parallel to the first and second longitudinal axes.

14. The orthopedic device of claim 13, wherein the curve of each curved member is along the longitudinal axis.

15. The orthopedic device of claim 13, wherein the operative engagement between the first connector-end and the second connector-end restricts independent rotational movement of the first rotating head relative to the second rotating head.

16. The orthopedic device of claim 13, wherein the each rotating head includes a length and a cavity extending the length of the rotating head.

17. The orthopedic device of claim 13, wherein the each rotating head includes a width and the aperture traverse the width of the rotating head.

18. An artificial orthopedic facet comprising:
a rod including a first curved section and a second curved section, the first curved section in a sliding engagement with the second curved section along a curved longitudinal axis to enable adjustment of the length of the rod along the curved longitudinal axis;
a first pedicle screw connected to the first curved section and a second pedicle screw connected to the second curved section; and
each of the first and second pedicle screws having a polyaxial head to enable lateral movement of each of the pedicle screws in at least one plane transverse to the curved longitudinal axis.

19. The artificial facet of claim 18 wherein the first and second pedicle screws are connected to the respective first and second curved sections with first and second set screws.

20. A method of creating an artificial facet joint comprising
a. positioning a first polyaxial head pedicle screw in bone;
b. position a second polyaxial head pedicle screw in bone adjacent to the first polyaxial head pedicle screw;
c. positioning a curved, longitudinally adjustable rod within each polyaxial head of the first and second polyaxial head pedicle screws; and
d. securing the adjustable rod within each polyaxial head.
